(19) United States
(12) Patent Application Publication
(10) Pub. No.: US 2010/0223236 A1
(43) Pub. Date: Sep. 2, 2010

(54) DYNAMIC AGGREGATION OF CONTENT BASED ON A FALLBACK DEFINITION

(75) Inventors: Paul Buckley Lorah, Redmond, WA (US); Corneliu Moiceanu, Bellevue, WA (US); Miguel Angel Gonzalez Perez, Kirkland, WA (US); Columbus Steward, JR., Bellevue, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/395,565

(22) Filed: Feb. 27, 2009

(51) Int. Cl. G06F 17/30; G06F 7/00

(52) U.S. Cl. 707/693; 707/E17.104

(57) ABSTRACT

A processing device and a method dynamically aggregates desired content. A user may specify a fallback definition for a pivot point via a user interface. The fallback definition may include at least a first and a second desired value for the pivot point. Only assets, including content having metadata with values corresponding to provided desired values for one or more pivot points, may be listed in a created list of assets. The list of assets may be sorted to provide a sorted list of assets, which may be ordered such that assets having content associated with a first desired value of the fallback definition appear before assets having content associated with a second desired value of the fallback definition. Each respective asset listed in the sorted list of assets may be added to a set of aggregated content when an equivalent asset is not already included in the set.

### BACKGROUND

Content for a system or application may include textual or multimedia content. If the system or the application is to be shipped to a number of locations, at which respective local people speak different languages, ideally, the content is localized for a locally-spoken language. However, in many cases, a complete set of desired content in a locally-spoken language may not exist. That is, little or no desired content may exist in the desired language.

In one existing system in which a complete content set exists in at least one language, such as, for example, English, all desired content in the at least one language may be manually aggregated first. Next, all desired content in a second desired language may be manually aggregated. Third, all desired content in a first desired language may be manually aggregated. Thus, according to the one existing system, if one wished to localize desired content using language “A” if assets corresponding to desired content in language “A” are available, using language “B” if assets corresponding to desired content in the language “A” are not available, and using language “C” if assets corresponding to desired content in the languages “A” and “B” are not available (assuming that all desired content is available in a default language, language “C”), one would first aggregate all desired language “C” assets, then all desired language “B” assets (which would overwrite any corresponding aggregated desired language “C” assets), and then all desired language “A” assets (which would overwrite any corresponding aggregated desired language “B” assets and any corresponding aggregated desired language “C” assets).

The method for aggregating desired content in the one existing system accomplishes a goal of providing desired content in a first desired language, if available, in a second desired language if the desired content in the first desired language is unavailable, and in a third desired language if the desired content in the first desired language and the second desired language is unavailable. However, if the desired content is available in more than one of the desired languages, corresponding equivalent assets are aggregated multiple times (with an earlier one of the aggregated desired content being overwritten with a later one of the aggregated desired content. Further, the method is performed manually, thereby taking up an individual's time, which may be used for other useful tasks.

The aggregated desired content may have a number of different uses. For example, the aggregated desired content of the one existing system is used to provide content for a “help” function.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

In various embodiments, a processing device and a method may be provided for dynamically aggregating desired content. Information regarding a desired set of content may be received by the processing device. The information may include a fallback definition associated with a pivot point and desired values associated with one or more other pivot points. The fallback definition may include a first desired value and a second desired value for the pivot point. A group of assets may be included in a complete content set. Each of the assets may include metadata. The processing device may select assets from the complete set of content, that include content having metadata with values corresponding to the fallback definition and the desired values. The processing device may produce a sorted list of assets from the list of assets. The sorted list of assets may be ordered such that assets having metadata including a first desired value of the fallback definition may appear before assets having metadata including a second desired value of the fallback definition. Each respective asset of the sorted list of assets may be added to an aggregated set of content when the aggregated set of content does not already include an asset equivalent to the respective asset. In some embodiments, a completed aggregated set of content may be used as content for a help function of a system or an application.

In embodiments having only one pivot point, for a given set of assets which have a same set of metadata values, no two assets may have a same value for a pivot point. In other embodiments having multiple pivot points, for a given set of assets which have a same set of metadata values, no more than one asset from the set of assets has a particular set of values for the multiple pivot points.

In some embodiments, the fallback definition may include desired values for a language pivot point. A user may provide the desired values via a user interface, such as, for example, a language fallback user interface.

In other embodiments, more than one fallback definition may be provided, each of which may include desired values for corresponding pivot points.

### DRAWINGS

In order to describe the manner in which the above-recited and other advantages and features can be obtained, a more particular description is described below and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 is a functional block diagram of an exemplary processing device which may implement embodiments consistent with the subject matter of this disclosure.

FIG. 2 is a flowchart illustrating an exemplary process for dynamically aggregating content in various embodiments.

FIG. 3 shows an exemplary language fallback selection user interface, which may be implemented in various embodiments.

FIG. 4 illustrates an exemplary complete set of content for an embodiment consistent with the subject matter of this disclosure.

FIG. 5 illustrates an exemplary created list of assets having pivot points with desired values.

FIG. 6 illustrates an exemplary sorted list of assets produced from the list of assets of FIG. 5.

FIG. 7 illustrates an exemplary aggregated set of content produced from the sorted list of assets of FIG. 6.

FIG. 8 shows an exemplary user interface for providing a fallback definition for a subject grouping pivot point, which may be implemented in various embodiments.

### DETAILED DESCRIPTION

Embodiments are discussed in detail below. While specific implementations are discussed, it is to be understood that this is done for illustration purposes only. A person skilled in the relevant art will recognize that other components and configurations may be used without parting from the spirit and scope of the subject matter of this disclosure.

### Overview

In embodiments consistent with the subject matter of this disclosure, a processing device and a method may be provided for dynamically aggregating desired content, without manual intervention, after providing information about the desired content, including a first desired language of the desired content, a second desired language of the desired content, and a third desired language of the desired content.

In exemplary embodiments, content may be stored in files, which may be referred to as assets. In addition to including content, which further may include textual content and/or multimedia content, each of the assets asset also may include metadata, which may include data pertaining to one or more pivot points. For example, the metadata may include data pertaining to a language pivot point, a subject matter grouping pivot point, a product name pivot point, a release version pivot point, and/or other types of information pertaining to other pivot points.

In some embodiments, a user may specify, via a language fallback selection user interface, desired values of a first pivot point pertaining to a language of content of an asset. The desired values of the first pivot point may include values corresponding to a first desired language and one or more fallback languages. The language fallback selection user interface is described in more detail later. The user may also specify the desired content by providing desired values of one or more pivot points.

In other embodiments, a user may specify a desired value and fallback values for pivot points of desired assets having content related to the specified desired values and fallback values. For example, the user may specify, via a user interface, a desired value and one or more fallback values for a pivot point pertaining to a product name, such as Windows Vista® (first desired value), Windows XP® (first fallback value or second desired value), Windows® Millennium Edition (second fallback value or third desired value). Windows Vista®, Windows XP®, and Windows® are registered trademarks of Microsoft Corporation, of Redmond, Wash. In this example, assets having content including a product name pivot point value representing Windows Vista® may be aggregated first, if found. If a particular asset including the product name pivot point value representing Windows Vista® cannot be found, then corresponding assets having content including a product name pivot point value representing Windows XP® may be aggregated, if found. If the corresponding assets having content including the product name pivot point value representing Windows Vista® and Windows XP® cannot be found, then corresponding assets having content including a product name pivot point value representing Windows® Millennium Edition may be aggregated.

Of course, pivot points may represent other types of data and therefore, a user interface may be implemented for specifying a desired value and one or more fallback values (or other desired values) for pivot points representing other types of data.

### Exemplary Processing Device

A method consistent with the subject matter of this disclosure may be performed by a processing device or a group of processing devices networked together for cooperatively performing the method.

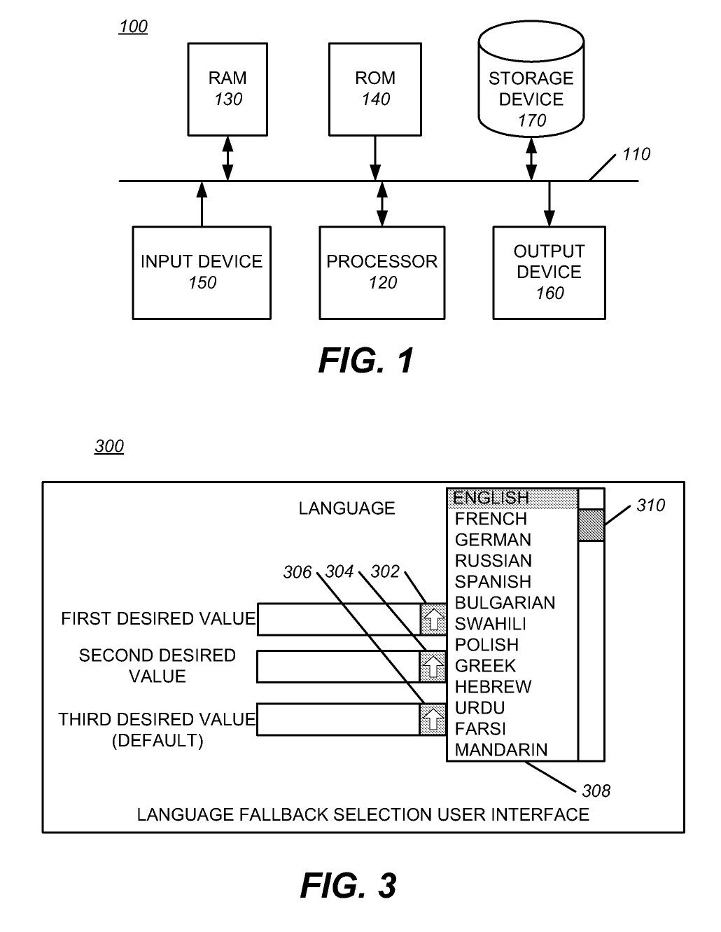

FIG. 1 is a functional block diagram of an exemplary processing device 100, which may be used to implement embodiments of a processing device consistent with the subject matter of this disclosure. Processing device 100 may be a desktop personal computer (PC), a notebook or laptop PC, or other type of processing device. Processing device 100 may include a bus 110, a processor 120, a random access memory (RAM) 130, a read only memory (ROM) 140, an input device 150, an output device 160, and a storage device 170. Bus 110 may permit communication among components of processing device 100.

Processor 120 may include one or more conventional processors that interpret and execute instructions. A memory may include RAM 130, ROM 140, or another type of dynamic or static storage device that stores information and instructions for execution by processor 120. RAM 130, or another type of dynamic storage device, may store instructions as well as temporary variables or other intermediate information used during execution of instructions by processor 120. ROM 140, or another type of static storage device, may store static information and instructions for processor 120.

Input device 150 may include a keyboard, a pointing device, an electronic pen, a touchscreen, or other device for providing input. Output device 160 may include a display, a printer, or other device for outputting information.

Processing device 100 may perform functions in response to processor 120 executing sequences of instructions contained in a tangible machine-readable medium, such as, for example, RAM 130, ROM 140 or other medium. Such instructions may be read into RAM 130 from another machine-readable medium or from a separate device via a communication interface (not shown).

### Exemplary Processing

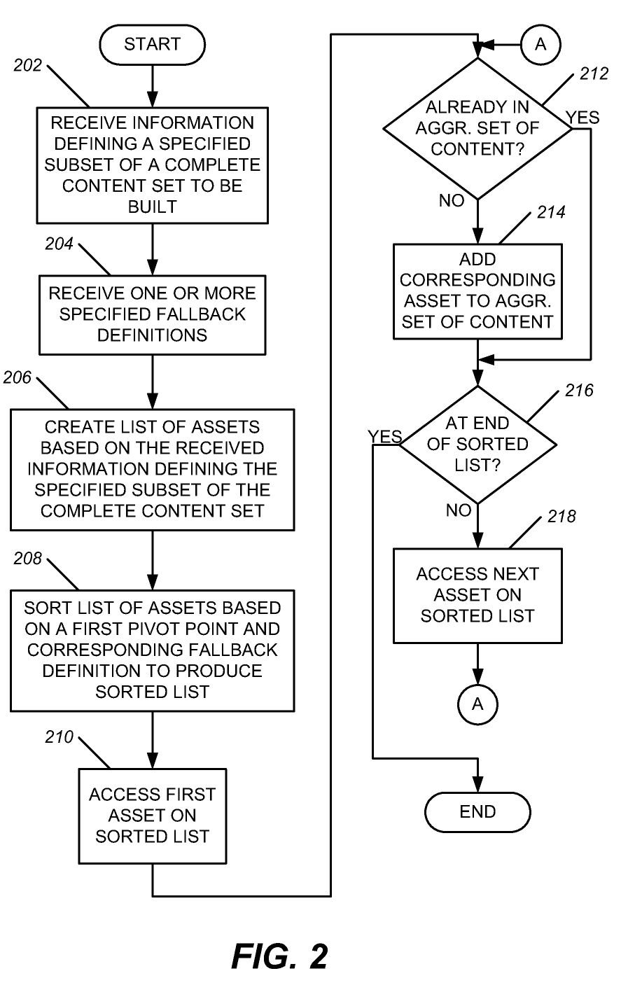

FIG. 2 is a flowchart of an exemplary process that may be performed in various embodiments for dynamically aggregating content. The process may begin with a processing device receiving information regarding a specified desired subset of a complete content set (act 202). The information may be received in a form of pivot point values, such as, for example, subject grouping pivot point values of “printing” and “networking”, indicating a desire for content having a subject grouping pivot point with a value indicating “printing” or “networking”. In some embodiments, the information may be provided by a user via an input device, such as, for example, input device 150. Of course, other pivot point values associated with other pivot points may be received.

Next, the processing device may receive one or more specified fallback definitions with respect to a pivot point (act 204). A fallback definition with respect to a pivot point may indicate a desire for content having a first desired value for the pivot point. If the content having the first desired value for the pivot point is not available, then the fallback definition may indicate a desire for content having a second desired value for the pivot point. If the content having the first desired value for the pivot point and the content having the second desired value for the pivot point are not available, then the fallback definition may indicate a desire for content having a third desired value for the pivot point.

The processing device may then create a list of assets based on the received information with respect to the specified desired subset of the complete content set (act 206). The assets listed in the created list of assets include content corresponding to the specified desired subset of the complete content.

Next, the processing device may sort the created list of assets, based on one or more pivot points and one or more corresponding fallback definitions, to produce a sorted list of assets (act 208). If one or more fallback definitions are received, the processing device may produce the sorted list of assets, such that assets having a pivot point value corresponding to a first desired value of a fallback definition may appear before assets having a pivot point value corresponding to a second desired value. The assets having a pivot point value corresponding to the second desired value may appear before assets having a pivot point value corresponding to third desired value. This will be explained more fully with respect to an example discussed below.

The processing device may then access a first asset of the produced sorted list (act 210). A check may be performed to determine whether an asset equivalent to the accessed asset is already included in an aggregated set of content (act 212), which may be empty initially. If an equivalent asset is not already included in the aggregated set of content, then the accessed asset may be added to the aggregated set of content (act 214).

The processing device may then determine whether an end of the sorted list of assets has been reached (act 216). If the end of the sorted list of assets has been reached, then the process may be completed. Otherwise, the processing device may access a next asset of the sorted list of assets (act 218). Acts 212-218 may then be repeated by the processing device.

Exemplary language fallback selection user interface 300 shows three desired settings which may be defined. However, in other embodiments fewer than three desired language values or more than three desired language values may be defined. In other embodiments, a fallback selection user interface may provide a facility for a user to define desired values for different pivot points.

The exemplary process illustrated by the flowchart of FIG. 2 may be understood more clearly when applied to an example. In the example, a user may specify a fallback definition for a language pivot point via a user interface, such as, for example, a language fallback selection user interface.

FIG. 3 illustrates an exemplary language fallback selection user interface 300. Via language fallback selection user interface 300, a user may provide a first desired language, a second desired language, and a third desired language. In some embodiments, the user may select each of the desired languages by selecting a corresponding pop-up menu icon 302, 304, 306 with a pointing device. A pointing device may be a computer mouse, an electronic pen, a stylus, a user's finger on a touchscreen, or another type of pointing device. Upon selecting one of corresponding pop-up menu icons 302, 304, 306 a pop-up menu 308, including possible choices, may appear. If all of the possible choices cannot simultaneously appear in pop-up menu 308, the user may select and drag a scrollbar 310 to view additional possible choices.

Language fallback selection user interface 300 is only exemplary. Other implementations of a language fallback selection user interface may permit defining of fewer than, or more than, three desired choices.

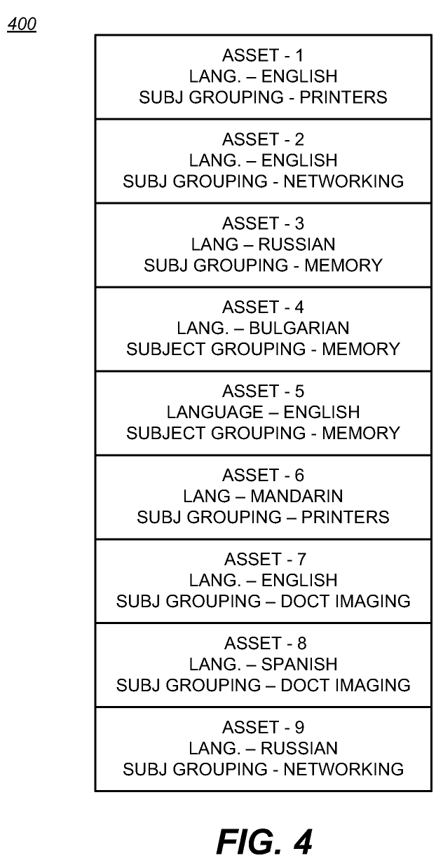

FIG. 4 illustrates an exemplary complete content set 400 for the example. In the example, for a given set of assets having the same metadata values, no two assets may have the same value for a pivot point. Exemplary complete content set 400 includes asset-1 through asset-9, each of which includes content. Each of the assets 1-9, in the example, has a language pivot point and a subject grouping pivot point. The language pivot point may indicate a language of content of an asset. The subject grouping pivot point may indicate a subject of content of an asset. Asset-1 has a language pivot point with a value indicating “English” and a subject grouping pivot point with a value indicating “printers”. Asset-2 has a language pivot point with a value indicating “English” and a subject grouping pivot point with a value indicating “networking”. Asset-3 has a language pivot point with a value indicating “Russian” and a subject grouping pivot point with a value indicating “memory”. Asset-4 has a language pivot point with a value indicating “Bulgarian” and a subject grouping pivot point with a value indicating “memory”. Asset-5 has a language pivot point with a value indicating “English” and a subject grouping pivot point with a value indicating “memory”. Asset-6 has a language pivot point with a value indicating “Mandarin” and a subject grouping pivot point with a value indicating “printers”. Asset-7 has a language pivot point with a value indicating “English” and a subject grouping pivot point with a value indicating “document imaging”. Asset-8 has a language pivot point with a value indicating “Spanish” and a subject grouping pivot point with a value indicating “document imaging”. Asset-9 has a language pivot point with a value indicating “Russian” and a subject grouping pivot point with a value indicating “networking”.

In the example, assets having a same value for a subject grouping pivot point may be considered to be equivalent. Thus, asset-1 and asset-6 may be considered equivalent, asset-2 and asset-9 may be considered equivalent, asset-3, asset-4, and asset-5 may be considered equivalent, and asset-7 and asset-8 may be considered equivalent.

Continuing with the example, while referring to FIG. 2, a processing device may receive information indicating a desired subset of the complete content set having a subject grouping pivot point with a value indicating “printers”, “networking”, or “memory” (act 202), and a fallback definition, with respect to a language pivot point, in which a first desired value of the language pivot point indicates “Bulgarian”, a second desired value of the language pivot point indicates “Russian”, and a third desired value of the language pivot point indicates “English” (act 204). Thus, in this example, the user entered a first desired choice of “Bulgarian”, a second desired choice of “Russian”, and a third desired choice of “English” via language fallback selection user interface 300 (FIG. 3).

All of the assets of the complete content set, which have a corresponding pivot point with a value indicating a last desired value, when combined, include content equivalent to all assets of the complete content set. Thus, for this example, all of the assets having a language pivot point with a value indicating “English”, when combined, are an English language equivalent of all of the assets of the complete content set. For this reason, the last desired value may be referred to as a default value.

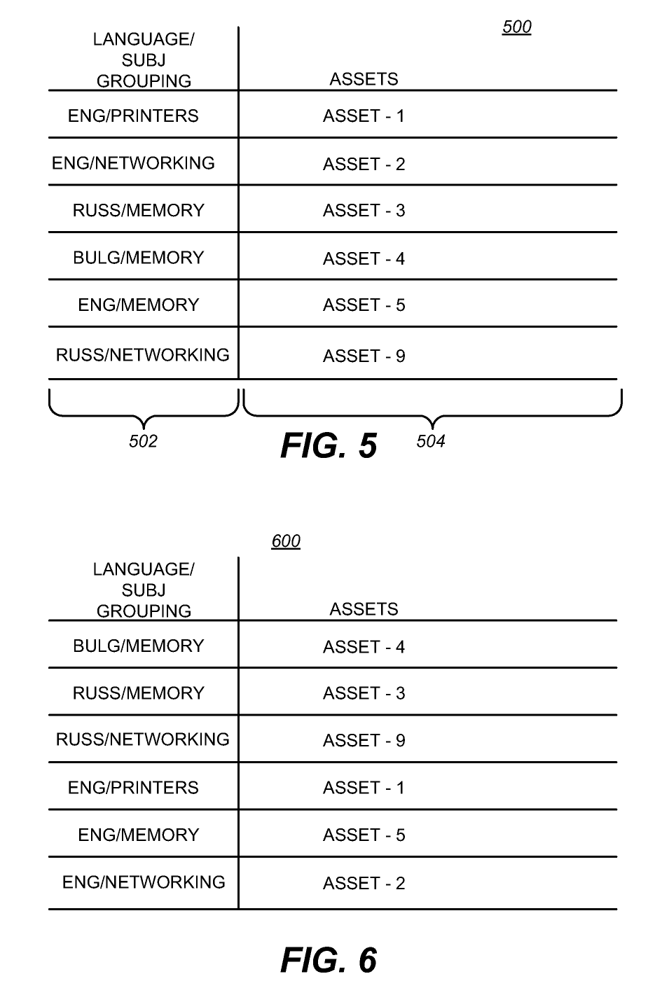

The processing device may refer to each asset of the complete content set and may create a list of assets satisfying desired values for each of the specified pivot points (act 206). FIG. 5 illustrates an exemplary created list of assets 500 for the example. A column 502 lists a language and a subject grouping corresponding to pivot point values of the language pivot point and the subject grouping pivot point, respectively. A column 504 lists assets including pivot points having pivot point values corresponding to entries of column 502. Each of the respective assets listed in column 504 is in a same row as a corresponding entry of column 502. Thus, for example, asset-1 has a language pivot point with a value indicating “English” and a subject grouping pivot point with a value indicating “printers”, asset-2 has a language pivot point with a value indicating “English” and a subject grouping pivot point with a value indicating “networking”, etc. Note that list of assets 500 does not include asset-6 through asset-8 because either each of the asset-6 through the asset-8 has a respective language pivot point with a value indicating a language other than any specified language (a language other than “Bulgarian”, “Russian”, and “English”), or each of the asset-6 through the asset-8 has a respective subject grouping pivot point with a value indicating a subject grouping other than any of the specified subject groupings (a subject grouping other than “printers”, “networking”, and “memory”).

The processing device may sort the list of assets, based on the one or more specified fallback definitions, to produce a sorted list of assets (act 208). Thus, in the example, assets having a subject grouping pivot point with a value indicating “printers”, “networking”, or “memory” and a language pivot point with a value indicating “Bulgarian” may appear in the sorted list of assets before assets having a subject grouping pivot point with a value indicating “printers”, “networking”, or “memory” and a language pivot point with a value indicating “Russian”. Assets having a subject grouping pivot point with a value indicating “printers”, “networking”, or “memory” and a language pivot point with a value indicating “Russian” may appear in the sorted list of assets before assets having a subject grouping pivot point with a value indicating “printers”, “networking”, or “memory” and a language pivot point with a value indicating “English”.

FIG. 6 shows an exemplary sorted list of assets 600 which may be produced according to the example. Sorted list of assets 600 has assets with the language pivot point indicating “Bulgarian” appearing before assets with the language pivot point indicating “Russian”. Assets with the language pivot point indicating “English” appear last in sorted list of assets 600.

The processing device may access a first asset on sorted list of assets 600 (act 210). Thus, asset-4 having a language pivot point indicating “Bulgarian” and a subject grouping pivot point indicating “memory” may be accessed. The processing device may then determine whether an asset equivalent to asset-4 already exists in an aggregated set of content (act 212). At this point, the aggregated set of content is empty. Therefore, the processing device determines that an asset equivalent to asset-4 does not already exist in the aggregated set of content. Therefore, the processing device may add the accessed asset, in this case asset-4, to the aggregated set of content (act 214).

The processing device may then determine whether an end of sorted list of assets 600 has been reached (act 216). Because the end of the sorted list of assets has not been reached, the processing device may access a next asset on sorted list of assets 600 (act 218), which is asset-3 having a language pivot point indicating “Russian” and a subject grouping pivot point indicating “memory”. The processing device may then determine whether an asset equivalent to asset-3 is already in the aggregated set of content (act 212). In this example, asset-4 in the aggregated set of content is equivalent to asset-3, but is localized in a different language. As a result, the processing device may not add asset-3 to the aggregated set of content.

The processing device may then determine whether the end of sorted list of assets 600 has been reached (act 216). Because the end of sorted list of assets 600 has not been reached, the processing device may access a next asset of sorted list of assets 600 (act 218), which in this example is asset-9 having a language pivot point indicating “Russian” and a subject grouping pivot point indicating “networking”. The processing device may then determine whether an asset equivalent to asset-9 is already in the aggregated set of content (act 212). Because an asset equivalent to asset-9 is not already in the aggregated set of content, the processing device may add the accessed asset (asset-9) to the aggregated set of content (act 214).

The processing device may then determine whether the end of sorted list of assets 600 has been reached (act 216). Because the end of sorted list of assets 600 has not been reached, the processing device may access a next asset of sorted list of assets 600 (act 218), which in this example is asset-1. Asset-1 has a language pivot point indicating “English” and a subject grouping pivot point indicating “printers”. The processing device may then determine whether an asset equivalent to asset-1 already exists in the aggregated set of content (act 212). Because an asset equivalent to asset-1 does not already exist in the aggregated set of content, the processing device may add the accessed asset (asset-1) to the aggregated set of content (act 214).

The processing device may then determine whether the end of sorted list of assets 600 has been reached (act 216). Because the end of sorted list of assets 600 has not been reached, the processing device may access a next asset on sorted list of assets 600 (act 218), which in this case is asset-5. Asset-5 has a language pivot point indicating “English” and a subject grouping pivot point indicating “memory”. The processing device may then determine whether the aggregated set of content includes an asset equivalent to asset-5 (act 212). In fact, asset-4, already included in the aggregated set of content, is equivalent to asset-5, but is localized in a different language (Bulgarian). Therefore, the processing device may not add asset-5 to the aggregated set of content.

The processing device may then determine whether the end of sorted list of assets 600 has been reached (act 216). Because the end of sorted list of assets 600 has not been reached, the processing device may access a next asset on sorted list of assets 600 (act 218), which in this example is asset-2 having a language pivot point indicating “English” and a subject grouping pivot point indicating “networking”. The processing device may then determine whether an asset equivalent to asset-2 already exists in the aggregated set of content (act 212). In fact, asset-9, included in the aggregated set of content, is equivalent to asset-2, but is localized in a different language (Russian). Therefore, the processing device may not add asset-2 to the aggregated set of content. The processing device may then determine whether the end of sorted list of assets 600 has been reached (act 216). At this point, the end of sorted list of assets 600 has been reached and the process may end.

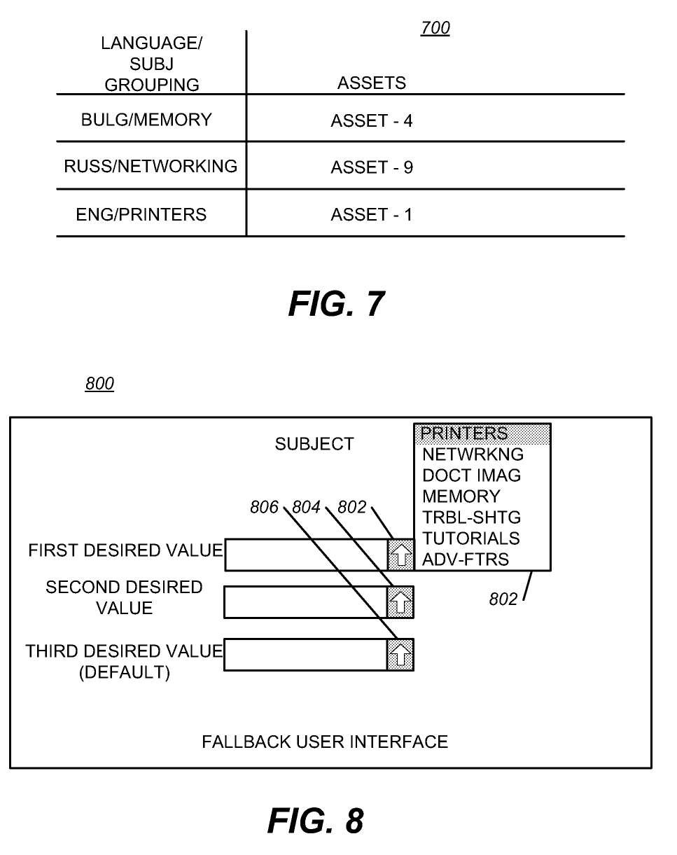

FIG. 7 illustrates an exemplary aggregated set of content 700 which may be produced by the above example. As shown in FIG. 7, aggregated set of content 700 includes asset-4 with a language pivot point indicating “Bulgarian” and a subject grouping pivot point indicating “memory, asset-9 with a language pivot point indicating “Russian” and a subject grouping pivot point indicating “networking”, and asset-1 with a language pivot point indicating “English” and a subject grouping pivot point indicating “printers”.

As one can easily see, the exemplary process illustrated by FIG. 2 and the above example may be used for aggregating at least a partially localized set of content.

### Generic Fallback User Interface

Although the previously-discussed example includes a subject grouping pivot point and a fallback definition for a language pivot point, other implementations may have different pivot points and one or more fallback definitions for other pivot points. As an example, FIG. 8 illustrates an exemplary fallback user interface 800 for a subject grouping pivot point. Through fallback user interface 800, the user may provide a first desired value for the subject grouping pivot point, a second desired value for the subject grouping pivot point, and a third desired value for the subject grouping pivot point. The desired values may be selected from a pop-up menu 802 in a same manner as described with respect to language fallback selection user interface 300. That is, the user may select one of pop-up menu icons 802, 804, 806 resulting in pop-up menu 802 of possible choices being displayed. The user may select a desired value from pop-up menu 802 in a same manner as previously discussed with respect to exemplary language fallback selection user interface 300.

Exemplary fallback user interface 800 shows three desired settings which may be defined. However, in other embodiments fewer than three desired pivot point values or more than three desired pivot point values may be defined. Further, in other embodiments, a fallback user interface may prove a facility for a user to define desired values for different pivot points.

In various embodiments an aggregated set of content may be used in a number of different ways. For example, the aggregated set of content may be used as content for a help file of a system or an application, or may have other uses.

### Conclusion

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Other configurations of the described embodiments are part of the scope of this disclosure. For example, in other embodiments, an order of acts performed by a process, such as the process illustrated in FIG. 2, may be different and/or may include additional or other acts. Additionally, in other embodiments, a fallback definition may be defined for other pivot points via a user interface different from the user interfaces illustrated in FIGS. 3 and 8.

Accordingly, the appended claims and their legal equivalents define embodiments, rather than any specific examples given.

We claim as our invention:

1. A machine-implemented method for dynamically aggregating content, the machine-implemented method comprising:
creating, by a processing device, a list of assets selected from a complete content set, each of the assets including content having at least one pivot point, the created list of assets being based, at least partially, on a fallback definition with respect to one of the at least one pivot point;
sorting, by the processing device, the list of assets based on the fallback definition; and
iterating, by the processing device, through the sorted list of assets and performing for each of the assets of the sorted list of assets:
accessing a respective asset listed in the sorted list of assets,
determining, by the processing device, whether an aggregate set of content already includes an asset equivalent to the respective asset, and
adding the respective asset to the aggregate set of content when the determining determines that the aggregate set of content does not already include an asset equivalent to the respective asset.

2. The machine-implemented method of claim 1, wherein:
the one of the at least one pivot point is a language pivot point and the fallback definition includes a first desired language and a second desired language, and
a complete content set exists for a last desired language.

3. The machine-implemented method of claim 2, wherein the sorting of the list of assets based on the fallback definition results in the sorted list of assets having ones of the assets in a first desired language being placed before ones of the assets in a second desired language.

4. The machine-implemented method of claim 3, further comprising:
specifying the fallback definition, including the first desired language, the second desired language, and a third desired language via a user interface.

5. The machine-implemented method of claim 3, wherein the at least one pivot point includes second pivot point representing a product name, a release version, or a subject grouping.

6. The machine-implemented method of claim 1, wherein each of the assets of the complete content set includes metadata, the metadata of each of the assets including a value for the one of the at least one pivot point.

7. The machine-implemented method of claim 1, wherein:
the one of the at least one pivot point represents a product and the fallback definition includes values representing a first desired product and a second desired product.

8. A tangible machine-readable medium having instructions recorded thereon for at least one processor, the tangible machine-readable medium comprising:
instructions for creating a list of assets from a complete content set such that each of the assets of the created list of assets has a first pivot point and a second pivot point satisfying corresponding specified values, a plurality of specified values with respect to the first pivot point being included in a fallback definition;
instructions for sorting the created list of assets to produce a sorted list of assets, the sorted list of assets being sorted, with respect to the first pivot point, according to the fallback definition;
instructions for performing, in a sorted order, for each of the assets of the sorted list of assets:
adding, to an aggregate set of content, a respective asset of the sorted list of assets when the aggregate set of content does not already include an asset equivalent to the respective asset.

9. The tangible machine-readable medium of claim 8, further comprising:
instructions for providing a user interface for a user to specify the fallback definition.

10. The tangible machine-readable medium of claim 8, wherein:
the fallback definition includes a first desired pivot point value, a second desired pivot point value and a third desired pivot point value,
ones of the assets having the first pivot point with the first desired pivot point value and the second pivot point with one of the corresponding specified values being added to the aggregate set of content if existing in the complete content set,
ones of the assets having the first pivot point with the second desired pivot point value and the second pivot point with the one of the corresponding specified values being added to the aggregate set of content only if existing in the complete content set and an asset having the first pivot point with the first desired first pivot point value and the second pivot point with the one of the corresponding specified values does not exist in the complete content set, and
ones of the assets having the first pivot point with the third desired pivot point value and the second pivot point with the one of the corresponding specified values being added to the aggregate set of content only if existing in the complete content set and an asset having the first pivot point with the first desired pivot point value and the second pivot point with the one of the corresponding specified values does not exist in the complete content set and the asset having the first pivot point with the second desired pivot point value and the second pivot point with the one of the corresponding specified values does not exist in the complete content set.

11. The tangible machine-readable medium of claim 10, wherein the first pivot point includes a value representing one of a plurality of subject groupings.

12. The tangible machine-readable medium of claim 10, wherein the first pivot point includes a value representing one of a plurality of languages.

13. The tangible machine-readable medium of claim 12, wherein the second pivot point includes a value representing one of a plurality product names, one of a plurality of release versions, or one of a plurality of subject groupings.

14. A processing device comprising:
at least one processor; and
a memory connected to the at least one processor, the memory further comprising:
instructions for providing a user interface for a user to specify values for a fallback definition associated with a first pivot point,
instructions for creating a list of assets from a plurality of assets, such that the created list of assets lists only ones of the plurality of assets having metadata corresponding to one or more specified groups of values of a plurality of pivot points;
instructions for adding, when found, an asset to an aggregate set of content, such that:
a complete aggregated set of content includes ones of the assets listed in the list of assets having metadata corresponding to a first plurality of specified values associated with the plurality of pivot points, the first plurality of specified values including a first desired value of the specified fallback definition, and
the complete aggregated set of content further includes ones of the assets listed in the list of assets having metadata corresponding to a second plurality of specified values associated with the plurality of pivot points when an asset having the first desired value of the fallback definition and other specified values of the second plurality of specified values associated with others of the plurality of pivot points is not found, the second plurality of specified values further including a second desired value of the fallback definition, and
the completed aggregate set of content further includes ones of the assets listed in the list of assets having metadata corresponding to a third plurality of specified values associated with the plurality of pivot points when an asset having the first desired value of the fallback definition and other specified values of the third plurality of specified values associated with others of the plurality of pivot points is not found, and an asset having the second desired value of the fallback definition and the other specified values of the third plurality of specified values is not found, the third plurality of specified values including a third desired value of the fallback definition.

15. The processing device of claim 14, wherein:
the first pivot point is a language pivot point, and
the instructions for providing a user interface for a user to specify values for a fallback definition associated with a first pivot point further comprise:
instructions for providing a language fallback selection user interface for the user to specify at least a first desired language, a second desired language, and a third desired language for the fallback definition associated with the first pivot point.

16. The processing device of claim 14, wherein:
the first pivot point is a subject grouping pivot point, and
the instructions for providing a user interface for a user to specify values for a fallback definition associated with a first pivot point further comprise:
instructions for providing a user interface for the user to specify at least a first desired subject grouping, a second desired subject grouping, and a third desired subject grouping for the fallback definition associated with the first pivot point.

17. The processing device of claim 14, wherein:
the plurality of pivot points include a language pivot point, a subject grouping pivot point, a release name pivot point, and a product name pivot point.

18. The processing device of claim 17, wherein the complete aggregated set of content is a partially localized help file for a system or an application.

19. The processing device of claim 14, wherein one of the specified values of the fallback definition of the first pivot point is associated with all assets of one complete content set.

20. The processing device of claim 14, further comprising:
instructions for providing a user interface for a user to specify values for a second fallback definition associated with a pivot point other than the first pivot point.
